(19) United States
(12) Patent Application Publication
(10) Pub. No.: US 2026/0360117 A1
(43) Pub. Date: Nov. 12, 2026

(54) OBJECT LOCATION DETECTION USING AUTOMATIC FEATURE EXTRACTION AND/OR FEATURE ASSIGNMENT

(71) Applicant: KUKA Deutschland GmbH, Augsburg (DE)

(72) Inventors: Kirill Safronov, Aindling (DE); Dominik Joho, Augsburg (DE); Yunus Ayar, Augsburg (DE)

(73) Assignee: KUKA Deutschland GmbH, Augsburg (DE)

(21) Appl. No.: 19/131,419

(22) PCT Filed: Nov. 15, 2023
(86) PCT No.: PCT/EP2023/081829

§ 371 Date: May 20, 2025

(30) Foreign Application Priority Data
Dec. 13, 2022 (DE) 10 2022 213 555.5
Dec. 13, 2022 (DE) 10 2022 213 557.1
Dec. 13, 2022 (DE) 10 2022 213 562.8
Dec. 13, 2022 (DE) 10 2022 213 568.7

(51) Int. Cl. G06V 10/77; B25J 9/16; G06V 10/82

(52) U.S. Cl. CPC G06V 10/7715; B25J 9/1612; B25J 9/1697; G06V 10/82

(57) ABSTRACT

A method for automatically extracting features and/or assigning features includes capturing with a capturing device an image with the perspective of a scene having at least one object; ascertaining a descriptor image on the basis of the captured image; and ascertaining at least one feature of the at least one object on the basis of the ascertained descriptor image.

### CROSS-REFERENCE TO RELATED APPLICATIONS

This application is a national phase application under 35 U.S.C. § 371 of International Patent Application No. PCT/EP2023/081829, filed Nov. 15, 2023 (pending), which claims the benefit of priority to German Patent Application Nos. DE 10 2022 213 555.5, DE 10 2022 213 557.1, DE 10 2022 213 562.8, and DE 10 2022 213 568.7, each filed Dec. 13, 2022, the disclosures of which are incorporated by reference herein in their entirety.

### TECHNICAL FIELD

The present invention relates to a method for automatically extracting features and/or assigning features, to a system for automatically extracting features, and to a computer program or computer program product.

### BACKGROUND

Feature-based object recognition typically consists of two steps: a first step with feature extraction, which usually comprises a manual selection of features such as circles, edges, corners, etc., and a selection or implementation of algorithms and/or methods for feature recognition, such as in particular the Hough transform for circle detection, etc. For edge detection, for example, suitable parameters, such as in particular with a Canny filter, must be found. A second step usually comprises feature assignment followed by pose recognition. Accordingly, the pose of the object is derived from the distortion and/or displacement of the object in different shots or perspectives of a scene comprising the object.

### SUMMARY

The object of the present invention is in particular to improve feature-based object recognition, in particular to automate feature extraction, and further in particular to automate feature assignment.

This object is achieved by a method and a system as described herein.

In one embodiment of the present invention, a method for automatically extracting features and/or assigning features is provided.

In one embodiment, the method comprises capturing an image with a perspective of a scene comprising at least one object by means of a capturing device. In one embodiment, the method comprises ascertaining a descriptor image on the basis of the captured image. In one embodiment, ascertaining the descriptor image is based on the image captured in particular by the capturing device. In one embodiment, ascertaining the descriptor image is based on a previously trained artificial intelligence or on a method which uses a trained artificial intelligence to ascertain, in particular, a descriptor image or with the aid of which the descriptor image is or can be ascertained. In one embodiment, the scene comprises at least one object, in particular at least one object for automatic feature extraction and/or feature assignment, further in particular at least one object that is to be gripped or is gripped on the basis of the automatic feature extraction and/or feature assignment.

In one embodiment, a perspective may be predetermined or fixed in advance, in particular in the case of fixedly installed capturing device(s), or a perspective may be, at least substantially, randomized or taken in a randomized manner.

In one embodiment, the method, in particular upstream of the method for automatically extracting features and/or assigning features described in particular above, comprises training an artificial intelligence with a step, in particular a first step, of capturing a first image with a first perspective of a scene using an in particular first capturing device. In one embodiment, the scene comprises at least one object, in particular at least one object for automatic feature extraction and/or feature assignment. In one embodiment, the method comprises a step, in particular a second step, of capturing a second image with a second perspective of the scene by means of the first or the same capturing device and/or a second capturing device. In one embodiment, the method comprises, in particular in a third step, ascertaining an assignment of pixels of the first image to pixels of the second image, in particular on the basis of the first perspective and the second perspective. In one embodiment, a perspective may be predetermined or fixed in advance, in particular in the case of fixedly installed capturing devices, or a perspective may be, at least substantially, randomized or taken in a randomized manner, in particular such that in one embodiment the first perspective differs from the second perspective. In one embodiment, the method comprises, in particular in a fourth step, ascertaining an assignment of pixels of the first image to pixels of the second image, in particular on the basis of depth data, wherein the first and/or the second capturing device is configured in one embodiment to record or capture depth data, in particular depth data are ascertained from the first image and/or the second image. In one embodiment, the method comprises, in particular in a fifth step, ascertaining a descriptor image on the basis of, in particular an inference of, the first and/or the second image. In one embodiment, ascertaining the descriptor image is based on one or the image, in particular the first image and/or the second image. In one embodiment, the image, in particular the first and/or the second image, is a two-dimensional image. In one embodiment, the method comprises, in particular in a sixth step, ascertaining at least one feature of the at least one object on the basis of the ascertained descriptor image.

The term “scene” as used herein should be understood in particular as a snapshot of a (relevant) environment, which comprises scenery with at least one object, in particular in a container. In one embodiment, the scene comprises the at least one object, which may in particular be in a container, and parts of the environment of the container, in particular parts of a robot, and further in particular parts of a system comprising the robot. In one embodiment, irrelevant parts of the scene can be (automatically) filtered out.

The term “perspective” as used herein should be understood in particular as the viewing direction of the capturing device, which is in particular oriented such that the scene, as described herein, is at least partially in the field of view of the capturing device, in particular the entire scene, in particular in applications of automated feature extraction and/or feature assignment for ascertaining a pose and/or a grip position in (robotic) gripping applications.

The term “descriptor image” as used herein should be understood in particular as a (learned) dense visual descriptor mapping that maps an image, in particular an RGB image, further in particular with full resolution, with space R^{WxHx3}, to a dense descriptor space, R^{WxHxD}, wherein in particular a D-dimensional descriptor vector (D) is present for each pixel; W and H refer in one embodiment to a position of the pixel in the image with a width and a height of the respective pixel in the image, in particular related to the width and height of the image. In one embodiment, this is done pixel by pixel, so that each pixel, in particular, comprises its own descriptor vector. This (automatic) procedure, in particular ascertaining the (at least one) descriptor vector, can in one embodiment be referred to as inference or is an inference.

The term “inference”, as used herein, should be understood in particular as “a conclusion automatically generated from a formal system” and further in particular as conclusion(s) drawn automatically by an inference engine, herein a system described below, and/or its means, and comprises in particular the pixel-by-pixel assignment and the derivation of the descriptor vector.

In this way, in one embodiment, an automatic feature selection can advantageously be realized, in particular on the basis of the descriptor image, which is not very (less) time-consuming, in particular compared to a manual feature selection. Furthermore, in one embodiment, features of a plurality of objects with a similar appearance, in particular similar objects, can advantageously be automatically extracted and/or assigned. In one embodiment, this advantageously makes it possible to dispense with the definition of new features of another, in particular similar, object.

In one embodiment, identical or similar features of similar objects can advantageously be ascertained (more) easily based on the ascertained descriptor image(s) for the respective objects, in particular correspondences between the respective images can be found, in particular in an automatic or automated manner, in particular with the aid of or on the basis of the descriptor image(s). If, in one embodiment, various features are predetermined or selected based on a reference image, in particular after a (completed) training of a neural network set up (for this purpose), in particular in such a way that a, in particular three-dimensional, pose estimation or ascertainment is possible on the basis of the features, and these in particular different features are distributed over the object, in particular over the object of the reference image, these can be or are advantageously (automatically) ascertained in the image, in particular if the object is different from the reference image, but in particular of the same type.

In one embodiment, the image, in particular the first image and/or the second image, can originate from or be extracted from a video captured by the capturing device, in particular the first and/or second capturing device, in particular if the capturing device has changed its perspective on the scene or the perspective has been changed. In one embodiment, the image may originate from or be extracted from a video captured by a capturing device. In one embodiment, the first image may originate from a video captured by a first capturing device and the second image may originate from or is extracted from a video captured by a second capturing device.

In one embodiment, the method further comprises ascertaining a pose of the at least one object, in particular on the basis of at least three ascertained features of the object.

In this way, in one embodiment, a pose of the at least one object can be ascertained advantageously with very little (less) time expenditure than in particular manual feature assignment.

In one embodiment, the method comprises ascertaining a grip position on the at least one object on the basis of an ascertained pose of the object. In one embodiment, the method comprises ascertaining a grip position for a gripping robot, in particular on the basis of an ascertained pose of the object.

This advantageously allows an object in the scene to be gripped (more) quickly by a gripping robot or a grip position for the gripping robot to be ascertained.

In one embodiment, the descriptor image is ascertained by means of at least one artificial neural network. In one embodiment, further steps of the method, in particular ascertaining an assignment and/or ascertaining at least one feature, can be or are carried out by means of an (artificial) neural network.

This advantageously makes it possible for features of a reference object, in particular features of a reference image, to be recognized or recognizable (more) quickly in similar objects, in particular when a plurality of objects is present in the scene. In one embodiment, this can further make it possible for a selection of features on the at least one object, in particular on a plurality of objects, to be automatically extracted or recognized and/or assigned or to be able to be assigned in a scene.

In one embodiment, ascertaining the pose of the at least one object is based on at least three predetermined features of a reference image, wherein the features of the reference image, in one embodiment, are predetermined based on an ascertained descriptor image of a reference object. In one embodiment, the reference image corresponds to a descriptor image of a reference object, in particular a descriptor image that comprises a reference object. In one embodiment, at least three different features of the object (in the scene) are assigned to the at least three predetermined features of the reference image.

In one embodiment, this advantageously makes it possible for the pose of the at least one object to be ascertained (more) quickly and/or more robustly. Furthermore, in one embodiment, ascertaining the pose of the at least one object by calculating a distortion and/or a displacement from a manually marked reference image, in particular manually, can Advantageously, in one embodiment, statistical recording of features of different (but similar) objects, in particular in one reference image or in a plurality of reference images, can be dispensed with. In particular, in one embodiment, ascertaining at least one feature is not limited to identical objects and/or objects with the same appearance, but can be applied to similar objects, and a pose of the at least one object, in particular of the plurality of (similar) objects, can be ascertained accordingly (as described herein). “Similar,” as used herein, should be used or understood in particular as being of the same species, genus, family and/or order or the like, in particular by analogy with biology.

In one embodiment, if the scene comprises a plurality of objects, in particular similar objects, the method comprises a step of ascertaining a probability, wherein the probability describes a similarity of a combination of ascertained features in the scene to the predetermined features of the reference image and/or the reference object, in particular in order to ascertain whether the features belong to a single object or to exclude combinations of features that are distributed in combination across a plurality of different objects. In one embodiment, the relative arrangement of the features to one another is ascertained from the, in particular predetermined, features of the reference image and/or a plurality of, in particular predetermined, features of a plurality of reference images.

In one embodiment, this advantageously allows an object in a scene with a plurality of objects, in particular with a plurality of similar objects, to be recognized or ascertained (more) robustly and/or (more) quickly, and, in one embodiment, the pose of the object to be recognized or ascertained (more) robustly and/or (more) quickly. Furthermore, in one embodiment, combinations of features that do not belong to only one object or in which features are distributed across a plurality of different objects can advantageously be excluded, at least substantially. In one embodiment, this makes it possible to prevent, at least substantially, an incorrect assignment of features to an object in the scene based on the probability, in particular to automatically assign ascertained features (more) clearly to an object. Without limiting the generality, in one embodiment, an object, in particular an object to be gripped, may be a fish stored in a box with other fish of a different species. Based on an ascertained descriptor image and in particular on the basis of predetermined features in a reference image, identical features of the different fish can be recognized or ascertained, in particular at least substantially. In one embodiment, the features are recognized or ascertained, independently of the plurality of objects, on the objects. By means of a probability, in particular as described herein, it is or can be ascertained whether the ascertained features belong to one object or to different objects, in the example to one or more of the fish. If, in one embodiment, the features in the example are assigned to a fish, in particular if a probability that the features belong to the object, here the fish, is greater than a predetermined probability, a pose of the fish can in particular be ascertained, further in particular by means of the ascertained and assigned features. Based on the ascertained pose, in one embodiment, a grip pose or grip position can be ascertained which is adjusted to the fish, with the aid of which pose or position the fish is or can be gripped.

In one embodiment, the method comprises ascertaining a grip pose on the basis of the probability. This advantageously makes it possible to find a grip pose that is adjusted to the ascertained features, in particular in comparison with methods that are based on a predetermined, in particular manually selected, grip position on the object and ascertain this position based on ascertained images.

In one embodiment, this advantageously makes it possible to ascertain a (more) advantageous grip position, in particular a grip pose, which can be or is adjusted in particular to (a plurality of) similar objects in a scene.

In one embodiment, the (first and/or second) capturing device is arranged on the at least one robot, in particular on a flange of the robot. In one embodiment, the robot is moved and/or aligned to capture the image, in particular the first image and the second image, in particular between capturing the first image and capturing the second image, further in particular to adjust the perspective, in particular the first and/or the second perspective. In one embodiment, the method comprises a step of moving and/or aligning the robot, in particular the flange of the robot, further in particular the capturing device arranged on the flange of the robot.

In one embodiment, this advantageously makes it possible for a basis for the assignment of pixels, as described herein, to be carried out or captured automatically. In one embodiment, this can be carried out automatically in particular, even if the capturing device is not attached to the robot, but rather, in one embodiment, at (different) predetermined points, in particular with a view of the scene, so that a first image can be or is captured with a first perspective and a second image can be or is captured with a second perspective, in particular one different from the first perspective.

The capturing device particularly preferably comprises a capturing device for capturing digital and/or two-dimensional, in particular three-dimensional, images, and can in particular comprise at least one 2D camera, 3D camera and/or at least two spatially separated cameras and/or at least one scanner, preferably for three-dimensional scanning. In one embodiment, an image mentioned here comprises (in each case) a point cloud and/or color information, preferably a three-dimensional point cloud, further in particular a point cloud with color information, in particular assigned to the points of the point cloud, and can in particular be such a point cloud or consist of such a point cloud. Accordingly, in particular, a three-dimensional point cloud and/or color information captured with the aid of a capturing device is referred to as an image (captured with the aid of the capturing device), which in one embodiment is generally a three-dimensional image and/or an image with color information.

In one embodiment of the present invention, a system for automatically extracting features and/or for operating a multi-axis machine, in particular a gripping robot, is provided. In one embodiment, the system is configured to carry out a method described herein. In one embodiment, the system comprises at least one robot arm, in particular a gripper guided by a robot arm. In one embodiment, the system comprises a capturing device, in particular a capturing device as described herein. In one embodiment, the capturing device is arranged on a flange of the at least one robot arm. In one embodiment, the system and/or its means comprise(s) means for ascertaining a descriptor image, in particular on the basis of an (automatically ascertained) inference of the image captured by the capturing device, in particular on the basis of the first image captured by the first capturing device and/or the second image captured by the second capturing device. In one embodiment, the system comprises means for ascertaining an assignment of pixels of a first image (captured by the capturing device) to pixels of a second image (captured by the capturing device), in particular if the system is configured or designed to train an (artificial) neural network as described herein.

In one development, the system and/or its means comprise(s) means for ascertaining a pose of the at least one object. In one development, the system and/or its means comprise(s) means for ascertaining a grip position on the at least one object, in particular on the basis of an ascertained pose of the at least one object. In one development, the system and/or its means comprise(s) means for ascertaining a probability.

In one embodiment of the present invention, a method for gripping an object using a gripping robot comprises a step of ascertaining a grip position as described herein. Furthermore, in one embodiment, the method comprises gripping the object using the gripping robot on the basis of the (ascertained) grip position.

Advantageously, in one embodiment, this makes it possible for the gripping robot to find a grip on the object (more) quickly or to carry out this grip (more) quickly, in particular in comparison to methods of the prior art.

A system and/or a means within the meaning of the present invention may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or a plurality of programs or program modules. The processing unit may be designed to process commands that are implemented as a program stored in a memory system, to detect input signals from a data bus and/or to issue output signals to a data bus. A memory system may comprise one or more, in particular different, memory media, in particular optical, magnetic, solid-state and/or other non-volatile media. The program may be designed in such a way that it embodies or is capable of carrying out the methods described herein, so that the processing unit is able to carry out the steps of such methods and thus, in particular, is able to operate or monitor the multi-axis machine, in particular the gripping robot.

In one embodiment, a computer program product may comprise, in particular be, an in particular computer-readable and/or non-volatile, memory medium for storing a program or instructions or with a program stored thereon or with instructions stored thereon. In one embodiment, execution of said program or said instructions by a system or controller, in particular a computer or an arrangement of a plurality of computers, causes the system or controller, in particular the computer(s), to carry out a method described herein or one or more steps thereof, or the program or instructions are configured to do so.

In one embodiment, one or more, in particular all, steps of the method are carried out completely or partially automatically, in particular by the controller or its means. In one embodiment, the system comprises the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts an exemplary system according to an embodiment of the present invention; and

FIG. 2 depicts a plurality of similar objects in a scene according to one embodiment;

FIG. 3 illustrates an exemplary object with ascertained features according to one embodiment;

FIG. 4 depicts a plurality of similar objects in a scene with ascertained features, combinations of features and a grip position;

FIG. 5 is a block diagram illustrating an exemplary method according to one embodiment.

### DETAILED DESCRIPTION

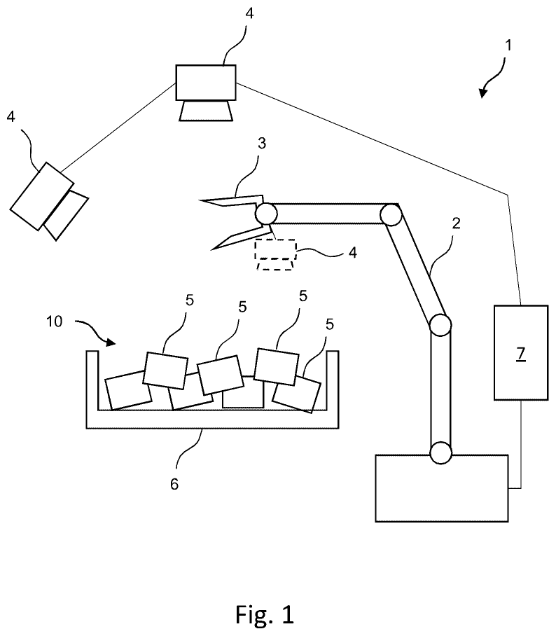

FIG. 1 shows an exemplary system 1 comprising a robot 2, on the flange of which a gripper 3 is arranged. Furthermore, FIG. 1 shows a capturing device 4 which has different perspectives on the scene 10 comprising a plurality of objects 5 and which is data-connected to the robot 2 via a processing unit. In one embodiment, the capturing device 4′ is arranged on the robot 2, in particular on the robot arm, further in particular on the flange of the robot arm (shown in dashed lines in FIG. 1). The objects 5 are shown in a container 6. The objects 5 are captured by the capturing device 4 in that the capturing device 4 captures an image from a perspective on the scene 10, in particular a first image from a first perspective on the scene 10 and a second image with a second perspective, which differs from the first perspective, on the scene 10. On the basis of the different perspectives, pixels of one image are assigned to pixels of the second image, so that in particular an assignment can be ascertained between the first image and the second image, in particular their pixels, in particular to one another, in particular during or for training an (artificial) neural network. In order to automatically capture a first image and a second image, in the event that the capturing device 4 is attached to or arranged on the flange of the robot, in particular on the flange of its robot arm, it can be moved by the robot, in particular by a robot controller, or a second image can be captured in a different pose of the capturing device achieved by the movement of the robot and/or the robot arm, in particular with a different (second) perspective on the scene 10. In one embodiment, a descriptor image can be ascertained based on the captured image, which descriptor image is or can be used in one embodiment to ascertain features.

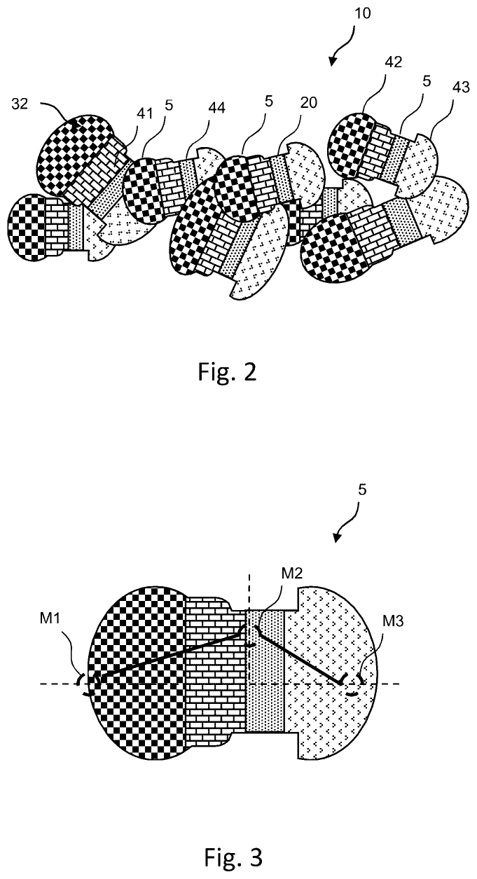

FIG. 2 schematically shows a scene 10 comprising a plurality of similar objects 5, which may in particular be located in a container (not shown). The (similar) objects 5 are represented by patterns that are exemplary for the descriptor image, in which in particular each pixel is assigned a feature vector. Regions with the same pattern are intended to indicate regions with the same features. A separation between the regions is clearly defined here; in some embodiments, this may comprise an, in particular continuous, transition between the regions, in particular descriptors may differ (slightly) from one another within the regions, but are assigned to one region by way of example in FIG. 2 and the following figures. Thus, similar objects 5, which differ in particular in size, length, width, height and/or the like and/or the characteristics of individual features, can comprise, at least substantially, identical features. On the basis of the ascertained descriptor image, a feature can then be ascertained, in particular for each object 5, which feature comprises, at least substantially, the same features in the descriptor image (reference is made to a representation of features in FIG. 3).

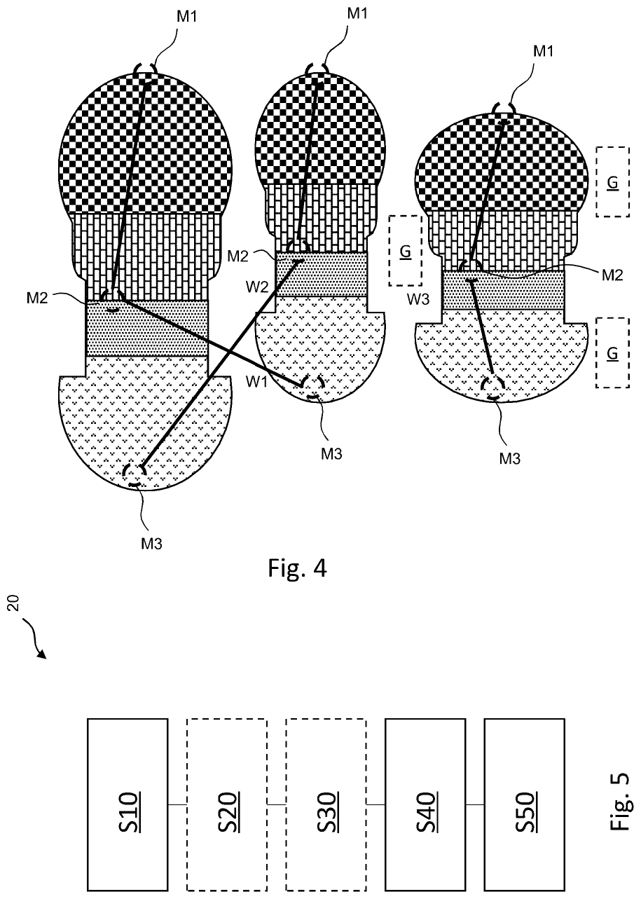

FIG. 3 schematically shows an object 5 in which features M1 to M3 were ascertained, in particular based on features of a reference image with predetermined features. The features M1 to M3 comprise, in particular, characteristic properties. Furthermore, a relationship, in particular a relative arrangement to one another, between the features M1 to M3 is shown schematically; for example, if feature M1 and feature M3 are connected by a (virtual) line (shown in dashed lines), feature M2 is arranged offset from this line (shown with a dashed line that is perpendicular to the connecting line of M1 and M3). Furthermore, the features M1 to M3 can also be directly connected via (virtual) lines. This can in particular be illustrated in FIG. 4, which shows three similar objects 5, each of which shows or comprises ascertained features M1 to M3 by way of example. Furthermore, in FIG. 4, a feature M1 is connected to a feature M2 and a feature M3. W1 to W3 denote probabilities of the respective connections of the features M1 to M3, which describe a similarity to the arrangement of the features M1 to M3 in a reference image with predetermined features M1 to M1. From this, it can be seen that the similarity of the arrangement of the features M1 to M3 is lower for the two objects 5 shown on the left side of FIG. 4 than for the object shown on the right in the figure. In particular, it can be deduced from this that the feature combinations shown on the left (probably) do not belong to the feature combination M1 to M3 of a single object 5 because the similarity to the feature arrangement M1 to M3 of a reference object, in particular a reference image, is lower.

Furthermore, FIG. 4 schematically shows a grip position G, in particular for a gripper of a gripping robot, which is shown by way of example with three gripping fingers. Based on the features M1 to M3, a pose of the object 5 can be ascertained, which, in one embodiment, can be used to ascertain a (more) optimal grip position G on the object.

FIG. 5 schematically shows a block diagram of a method 20 which shows the steps of the method 20, wherein S10 represents, by way of example, capturing a first image with a first perspective, S20 represents capturing a second image with a second perspective different from the first perspective, S30 represents ascertaining an assignment of pixels of the first image to pixels of the second image, S40 represents ascertaining a descriptor image on the basis of the captured first image, in particular on the basis of an inference, and S50 schematically represents ascertaining at least one feature M1, M2, M3 on the basis of the ascertained descriptor image. S20 and S30 are dashed to schematically illustrate that ascertaining S40 a descriptor image is or can be carried out on the basis of one, in particular exactly one, captured image and in particular S20 and S30 are or can be used in or for training an (artificial) neural network.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 System
2 Robot
3 Gripper
4 Capturing device
5 Object
6 Container
7 Processing apparatus
10 Scene
20 Method
M1, M2, M3 Ascertained features
W1, W2, W3 Ascertained probabilities
S10 Capturing a first image
S20 Capturing a second image
S30 Ascertaining an assignment
S40 Ascertaining a descriptor image
S50 Ascertaining at least one feature

What is claimed is:

1. Method (20) for automatically extracting features and/or assigning features, having the steps of:
capturing (S10) an image with a perspective of a scene (10) comprising at least one object (5) by means of a capturing device (4);
ascertaining (S40) a descriptor image on the basis of the captured image; and
ascertaining (S50) at least one feature (M1, M2, M3) of the at least one object (5) on the basis of the ascertained descriptor image.

2-10. (canceled)

11. Method (20) according to claim 1, characterized in that the method (20) comprises ascertaining a pose of the at least one object (5) on the basis of the at least one feature (M1, M2, M3).

12. Method (20) according to claim 11, characterized in that ascertaining the pose of the at least one object (50) is based on at least three predetermined features (M1, M2, M3) of a reference image, wherein at least three different ascertained features (M1, M2, M3) of the object (5) are assigned to the at least three predetermined features (M1, M2, M3) of the reference image.

13. Method (20) according to claim 1, characterized in that the descriptor image is ascertained by means of artificial intelligence, in particular by means of at least one artificial neural network.

14. Method (20) according to claim 13, characterized in that if the scene comprises a plurality of, in particular similar, objects (5), the method (20) further comprises a step of ascertaining a probability (W1, W2, W3), wherein the probability (W1, W2, W3) describes a similarity of a combination of ascertained features (M1, M2, M3) in the scene to the predetermined features (M1, M2, M3) of the reference image and/or a reference object.

15. Method according to claim 1, characterized in that the, in particular first and/or second, capturing device (4, 4′) is arranged on the at least one robot, in particular on a flange of the robot.

16. Method (20) according to claim 1, characterized in that the method (20) comprises ascertaining a grip position (G) on the at least one object (5), in particular a grip position (G) for a gripping robot, in particular on the basis of the ascertained pose of the object (5).

17. Method for gripping an object using a gripping robot, having the steps of:
ascertaining a grip position (G) according to the preceding claim; and
gripping the object (5) using the gripping robot on the basis of the grip position (G).

18. System for automatically extracting features and/or for operating a multi-axis machine, in particular a gripping robot, which system is configured to carry out a method according to claim 1 and/or comprises:
a robot arm and a gripper guided by the robot arm;
at least one capturing device, wherein the capturing device is arranged in particular on a flange of the robot arm;
means for ascertaining a descriptor image.

19. Computer program or computer program product, wherein the computer program or computer program product includes instructions, in particular stored on a computer-readable and/or non-volatile memory medium, which, when executed by one or more computers or a system, cause the computer(s) or the system to carry out a method according to claim 1.
